(19) United States
(12) Patent Application Publication
(10) Pub. No.: US 2005/0042582 A1
(43) Pub. Date: Feb. 24, 2005

(54) Iterative algorithm for creating nutritionally balanced food lists

(76) Inventor: Joseph Douglas Graves, Brentwood, MD (US)

Correspondence Address: JOSEPH DOUGLAS GRAVES, 3404 TILDEN ST., BRENTWOOD, MD, 20722, US

(21) Appl. No.: 10/922,995

(22) Filed: Aug. 23, 2004

Related U.S. Application Data
(60) Provisional application No. 60/496,927, filed on Aug. 22, 2003.

(51) Int. Cl. G09B 19/00

(52) U.S. Cl. 434/127

(57) ABSTRACT

A nutrition planning system implemented in the form of an iterative algorithm that guides users to create a list of foods that matches a chosen set of nutritive standards. The algorithm builds a Nutrient Deficiency/Surplus Profile (NDSP), which is then compared against each food in a list of favorites. The result is a score for each food, which is used to guide a user, or an automatic algorithm to the appropriate choices. The algorithm continues until the desired level of compliance has been reached.

This patent application relies on provisional patent application: Ser. No. 60496927 dated Aug. 22, 2003

### FIELD OF THE INVENTION

The present invention relates to a computer method for creating a nutritionally balanced list of foods in which an iterative algorithm will help a user build and edit a food list such that it matches a specific set of nutritive standards.

### BACKGROUND OF THE INVENTION

In the past, numerous methods of entering foods into a computer, and determining the sum of their nutritive values have been implemented. The problem with these systems is that while they do reveal deficiencies and excesses in nutrition, they do not provide a clear system that guides the user in the selection of foods so that the user can easily create a list of foods that matches desired levels.

Basic systems for summing nutrients in lists of foods and comparing the result to nutritive standards are known in the art, and have taken various forms (U.S. Pat. Nos. 4,321,674; 4,380,802; 4,891,756; 4,894,793; 5,412,560; 5,704,350 and 6,585,516). These systems have been also introduced in portable units, designed to be easily transported, held in the hand, or worn on the wrist (U.S. Pat. Nos. 4,855,945; 5,691,927 and 6,675,041).

Other nutrient summing systems have focused on simplifying the method of entering the foods into the system, such as by weighing foods (U.S. Pat. Nos. 5,033,561 and 5,233,520), and by scanning barcodes of purchased foods and looking up their nutritive values from a database (U.S. Pat. Nos. 5,412,564 and 5,819,735). The shortcoming of these systems is that they simply make the user aware of the nutritive deficiencies and surpluses in the list of foods entered into the system. While this helps in identifying problems in a user's diet, it does little to guide a user who is trying to design a nutritionally balanced list of foods.

Systems that help the user adjust the calorie levels of foods to match a desired level are also known in the art, such as a system that copies the foods from a previous food list entered by the user and automatically reduces or increases the amount consumed as necessary (U.S. Pat. No. 4,924,389), or by providing the user with predefined, nutritionally balanced meals that the user may modify by replacing foods, the size of which are automatically modified to provide the same number of calories (U.S. Pat. Nos. 4,954,954 and 6,083,006), or by a system that randomly selects a meal from a predefined list and adjusts serving sizes so that calorie intake is acceptable (U.S. Pat. App. No. 20020046060).

While balancing calories is helpful, a far more comprehensive goal is to provide a clearly defined method for assisting the user in creating lists of foods such that the sum of all of the nutrients of the foods in the list fall within a desired range. Several simplistic approaches have been introduced, but a comprehensive clear algorithm for balancing all nutrients is still lacking. One weight loss method utilizes a computer to provide a report of the difference between consumed nutrients and desired levels. The report is provided to a registered dietician who recommends foods to consume to reach nutritive goals (U.S. Pat. No. 4,951,197). Another method assigns points to various foods for levels of calories, total fat, and dietary fiber which help the user choose foods to match desired totals (U.S. Pat. Nos. 6,040,531; 6,436,036 and 6,663,564). While this method works for a few nutrients, it is extremely cumbersome for a full range of vitamins, minerals and other nutrients necessary for a completely balanced diet.

### SUMMARY OF THE INVENTION

It is a principal object of the present invention to avoid the shortcomings and drawbacks of the prior art by introducing a new method for building and modifying a food list so that the sum of the nutrient levels matches a particular set of standards.

The present invention obviates the drawbacks and shortcomings encountered with the prior art systems by introducing an iterative algorithm that by repeated action will create a food list that matches specific nutritive standards. This iterative algorithm may be implemented on a range of systems, and has several key parts.

An integral part of the iterative algorithm of the present invention is a database of nutritive values of the foods that are to be used in the algorithm. It also requires information about the typical serving size for each food. Many sources of food nutrient data exist. An example is the database regularly released by the Agricultural Research Service of the United Stated Department of Agriculture.

The foods considered in the iterative algorithm of the current invention may consist of all of the foods in the food database, or more practically, a subset defined to represent an individual's tastes, or the foods available within an institution. This “favorites list”, is the list from which the iterative algorithm chooses foods to create the food list that matches the desired nutritive standards.

Another key element of the iterative algorithm of the current invention is a set of values indicating the desired level of each nutrient to be considered in the algorithm. This algorithm utilizes the new Dietary Reference Intake (DRI) system from the Food and Nutrition Board of the Institute of Medicine that has just replaced the Recommended Dietary Allowance (RDA) system. The new DRI system not only provides a desired level of consumption for each nutrient, it also provides upper and lower values which allow this algorithm to determine what level of excess or deficiency is acceptable for each nutrient. To drive the user to action, an intuitive set of measures (such as letter grades) is derived from the data that gives the user an intuitive understanding of the level of compliance. The DRI system provides a scientifically valid basis for assigning letter grades since they may now be attached to upper and lower limits as well as a desired level. These intuitive indicators drive the user to action, causing an obsessive response to “get all A's” for example.

Another integral part of the iterative algorithm of the present invention is a means for creating a food list, the nutritive values of which are to be summed and compared to the desired levels. This list can be used for planning daily or weekly food intakes, or any other situation that requires a list of foods to match a set of nutritive requirements. The list may be created and accessed through a variety of means such as web applications, spreadsheets, custom software, and database languages.

The algorithm begins with the food list empty. The goal is to guide the user to the correct choices such that the sum of the nutritive values of the foods in the food list meets a chosen set of nutritive standards. The user may choose to add several desired foods before starting the algorithm to force the algorithm to create a balanced food list that includes those foods.

The first step of the iterative algorithm of the present invention is to create a Nutrient Deficiency/Surplus Profile (NDSP). The NDSP is an array of numbers indicating the level of deviation between desired and actual levels for each nutrient.

The second step in the iterative algorithm is to compare the nutritive levels of a typical serving of each food in the favorites list to the current state of the NDSP. Each food is given a score indicating the level to which the nutrient profile of that food matches that of the NDSP. Higher scores indicate a better match. Foods that contribute to an excessive surplus for any nutrient have their scores lowered.

The third step in the iterative algorithm of the present invention is to use the scores and the NDSP to choose foods to add to or remove from the food list. The user, or an automatic algorithm chooses foods from the favorites list with higher scores, and adds them to the food list. Conversely, if the NDSP indicates a surplus, the foods that contribute strongly to the surplus may be removed from the food list, or their portion sizes may be reduced.

The fourth step in the iterative algorithm is to determine if the sum of the nutritive values of the foods in the food list is sufficiently close to the nutritive standards chosen for the algorithm. If the algorithm uses letter grades, this could happen when all grades are a “B or above”. If the level of compliance has not been reached, the algorithm begins again. If it has been reached, the algorithm ends.

### BRIEF DESCRIPTION OF THE DRAWINGS

These and other features and advantages of the present invention will become more apparent from the following description when taken in connection with the accompanying drawing which shows, for purpose of illustration only, the flow of the iterative algorithm, and wherein:

FIG. 1 is a flow diagram describing the process as a sequence of steps.

### DETAILED DESCRIPTION OF THE DRAWINGS

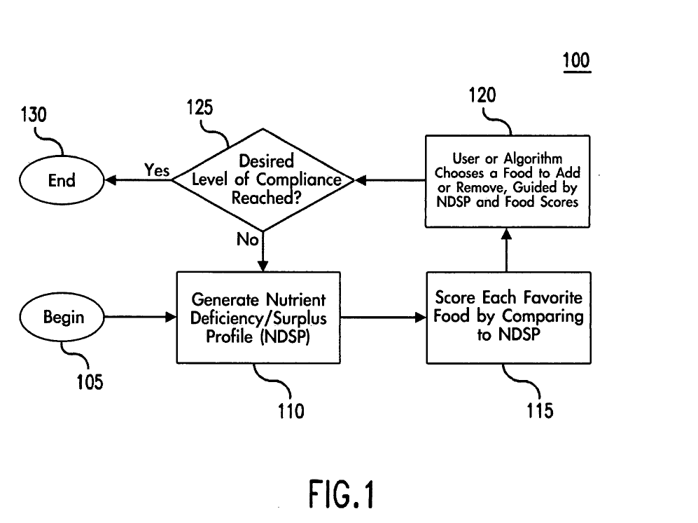

Referring now to the drawing, particularly, FIG. 1, the iterative algorithm generally designated by reference number 100 is intended to guide the user to create a nutritionally balanced list of foods. The algorithm begins 105 with an empty food list, or with some pre selected foods chosen by the user. The algorithm begins 110 by determining how well the sum of the nutritive values of the foods in the food list match the chosen nutritive standards. The algorithm continues 115 by scoring each food in the favorites list according to how well its nutrient profile matches that of the NDSP. The user is then guided to the best choices 120 by viewing the foods in the favorites list sorted according to the scores assigned in the previous step. Once the appropriate food has been added or removed, the decision to continue 125 is made based on the current level of compliance. If the algorithm continues, a new NDSP is generated 110, otherwise, the process ends 130.

1: An iterative algorithm for building a nutritionally balanced list of foods comprising the steps of
(a) creating an array of values indicating the level of deficiency/surplus in the current food list when compared to a selected standard;
(b) comparing each food in a list of favorites to the deficiency/surplus profile, and generating a score for each food indicating the level of match;
(c) using the scores to guide a user or algorithm in selecting a food to add to the list; and
(d) repeating the above steps until the desired level of compliance is reached.
